(19) United States
(12) Patent Application Publication
(10) Pub. No.: US 2014/0211304 A1
(43) Pub. Date: Jul. 31, 2014

(54) SURGICAL MICROSCOPE SYSTEM

(71) Applicant: MITAKA KOHKI CO., LTD., Tokyo (JP)

(72) Inventors: Katsuyuki NAKAMURA, Tokyo (JP); Masao DOI, Tokyo (JP); Katsushige NAKAMURA, Tokyo (JP)

(73) Assignee: MITAKA KOHKI CO., LTD., Tokyo (JP)

(21) Appl. No.: 14/165,837

(22) Filed: Jan. 28, 2014

(30) Foreign Application Priority Data
Jan. 30, 2013 (JP) 2013-015347

(51) Int. Cl. G02B 21/36; G02B 21/20; G02B 21/00

(52) U.S. Cl. CPC G02B 21/368; G02B 21/0012; G02B 21/20
USPC 359/363

(57) ABSTRACT

A surgical microscope system includes a camera 20. The camera 20 includes CCDs 21 and a focusing mechanism (41, 42, 43). If an image displayed on an electronic image display unit 5 is unclear due to a focusing error, the focusing mechanism is operated to focus the image and make the image clearly visible. Without regard to a focusing operation conducted by a doctor D1 on a surgical microscope 4, an assistant D2 on the electronic image display unit is able to manipulate the focusing mechanism and observe clear images on the electronic image display unit.

### BACKGROUND OF THE INVENTION

1. Field of the Invention

The present invention relates to a surgical microscope system.

2. Description of Related Art

The surgical microscope system typically includes a surgical microscope, a camera, and an electronic image display unit. The surgical microscope is installed on a medical stand and is vertically movable on the medical stand. The camera is installed on the surgical microscope and picks up a pair of electronic images of an affected part or a target part of a patient, the electronic images having binocular parallax to realize a stereoscopic view. The electronic image display unit includes a pair of left and right display panels to display the pair of electronic images, respectively, so that an observer may see a stereoscopic image of the target part through a pair of left and right eyepiece parts of the display unit. A related art is disclosed in, for example, Japanese Unexamined Patent Application Publication No. 2004-320722.

### SUMMARY OF THE INVENTION

According to the related art, an operator of the surgical microscope conducts a focusing action by manipulating an internal optical system of the surgical microscope and an action of adjusting the surgical microscope to a focal point of the observer's eye by vertically moving the surgical microscope on the medical stand. Vertically moving the surgical microscope frequently results in breaking the focused state of the internal optical system of the surgical microscope and displaying unfocused images on the display panels of the electronic image display unit. If this happens, the observer of the display unit sees unclear images.

In consideration of this problem, the present invention provides a surgical microscope system having a surgical microscope, a camera, and an electronic image display unit, capable of displaying clear images on the electronic image display unit irrespective of an internal out-of-focus condition of the surgical microscope.

According to an aspect of the present invention, the surgical microscope system includes a surgical microscope that is vertically movably supported and has an objective optical system, variable-power optical systems, and a pair of left and right eyepiece parts to form two main optical paths, at least one of the main optical paths being branched into a sub-optical path. A camera is installed on the surgical microscope and has a pair of left and right imaging elements to receive light from the sub-optical path and provide electronic images. An electronic image display unit has a pair of left and right display panels to display the electronic images provided by the camera and a pair of eyepiece parts through which an observer is able to observe the displayed images with his or her eyes, respectively. And a focusing mechanism is arranged for the imaging elements in the camera.

### BRIEF DESCRIPTION OF THE DRAWINGS

FIG. 1 is a perspective view illustrating a surgical microscope system according to a first embodiment of the present invention;

FIGS. 2 and 3 are views illustrating an internal structure of a surgical microscope of the surgical microscope system;

FIG. 4 is a view explaining optical systems of the surgical microscope;

FIG. 5 is a view illustrating a relationship between a camera and an electronic image display unit of the surgical microscope system;

FIG. 6 is a sectional view illustrating an internal structure of the camera;

FIG. 7 is a view illustrating filters arranged in the camera;

FIGS. 8 and 9 are views illustrating an internal structure of the electronic image display unit;

FIG. 10 is a perspective view illustrating a surgical microscope and a camera of a surgical microscope system according to a second embodiment of the present invention;

FIG. 11 is a perspective view illustrating an internal structure of the surgical microscope of FIG. 10; and

FIG. 12 is a sectional view illustrating an internal structure of the camera of FIG. 10.

### DESCRIPTION OF PREFERRED EMBODIMENTS

### First Embodiment

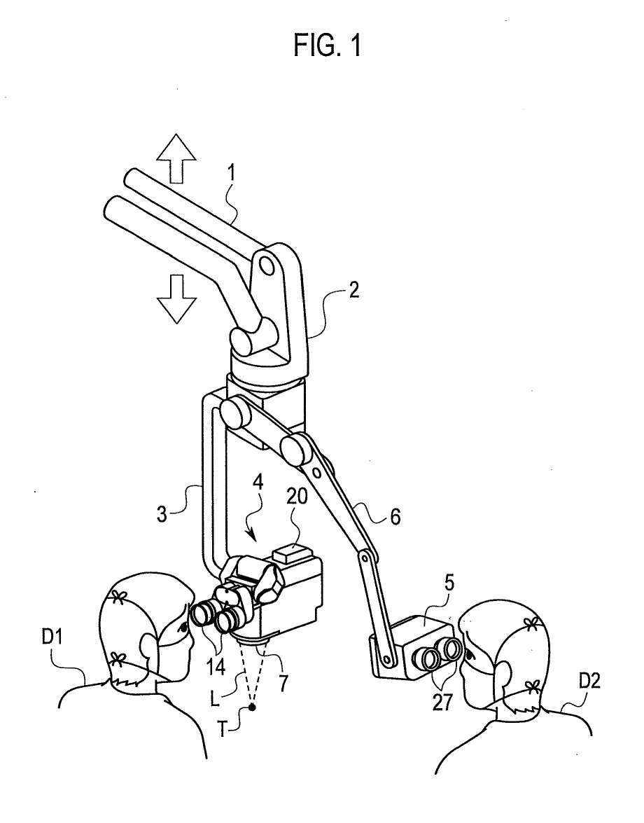

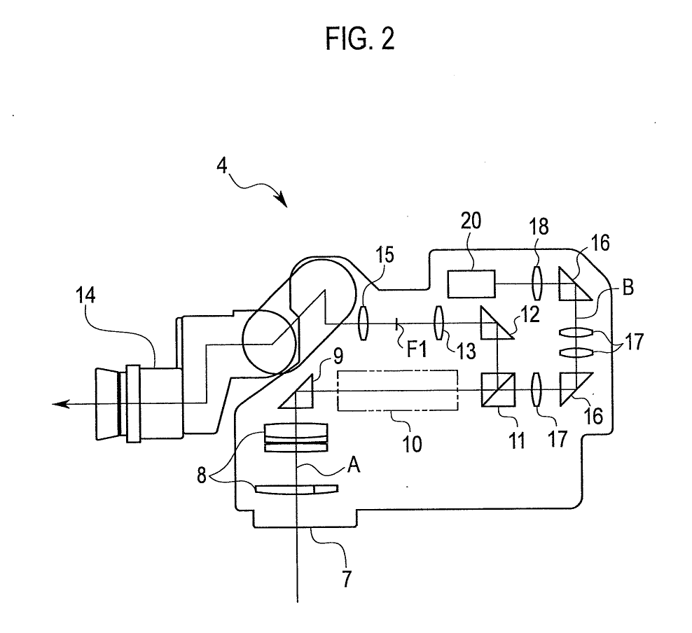

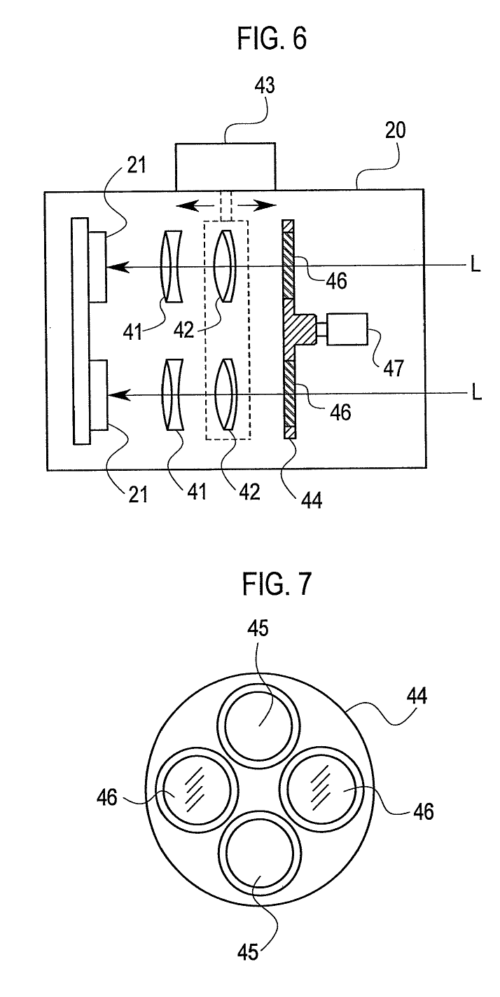

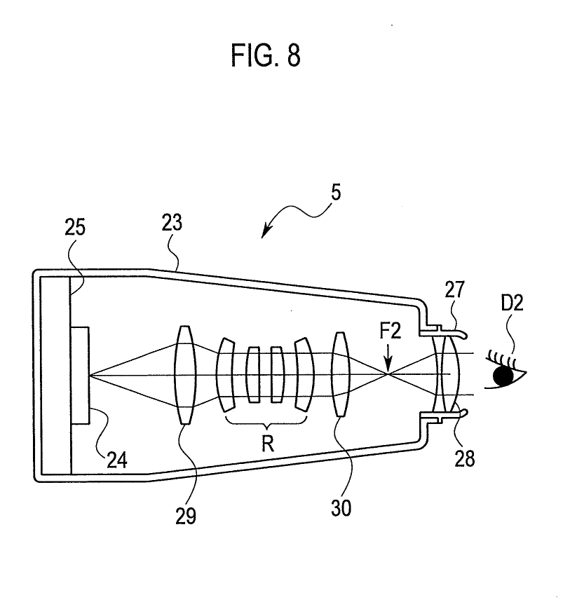

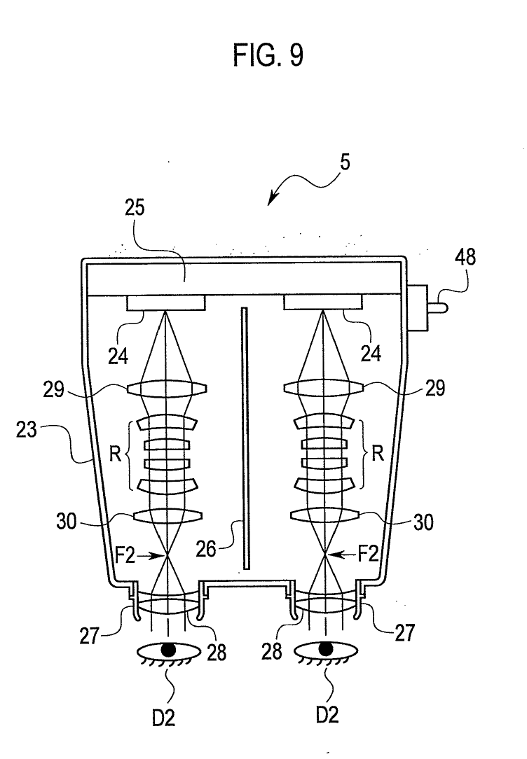

A surgical microscope system according to the first embodiment of the present invention will be explained with reference to FIGS. 1 to 9.

In FIG. 1, a support arm 1 horizontally extends from a medical stand (not illustrated) arranged in an operating room. A front end 2 of the support arm 1 is attached to a suspension aim 3 having a U-shape. A lower end of the suspension aim 3 supports a surgical microscope 4 manipulated by a doctor D1.

On the right side of the surgical microscope 4, an electronic image display unit 5 is supported with a support arm 6 that extends from the front end 2 of the support aim 1. The display unit 5 is manipulated by an assistant D2 who is on the right side of the doctor D1.

The surgical microscope 4 allows a stereoscopic observation. For this, left and right main optical paths A each is defined inside the surgical microscope 4. At a lower part of the surgical microscope 4, a light inlet 7 is formed. Above the light inlet 7, an objective optical system 8 having lens groups is vertically arranged. Above the objective optical system 8, prisms 9 are arranged. Arranged behind the prisms 9 are horizontal variable-power optical systems 10 having lens groups.

Behind the variable-power optical systems 10, beam splitters 11 and prisms 12 are vertically arranged to upwardly and then forwardly bend the optical paths A. The optical paths A pass through imaging optical systems 13 to form primary images F1 and reach eyepiece parts 14. The eyepiece parts 14 have eyepiece optical systems 15, respectively, through which the doctor D1 optically three-dimensionally observes the primary images F1.

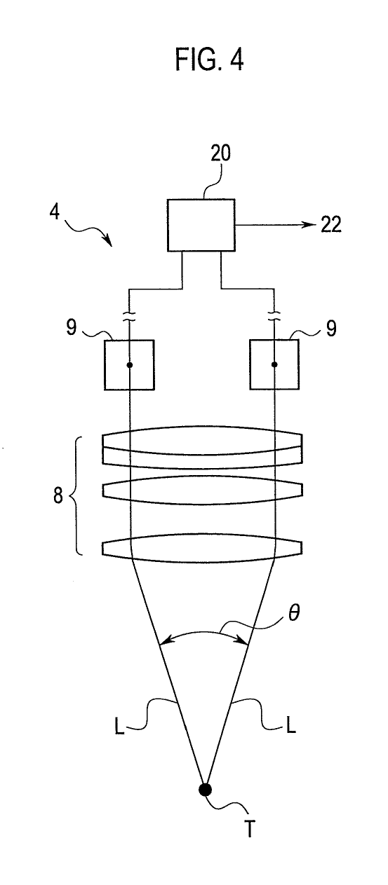

As illustrated in FIG. 4, light L from an affected part, i.e., a target part T of a patient is guided at a convergence angle “θ (theta)” into the objective optical system 8. The light L is divided by the objective optical system 8 into the two optical paths A that are guided through the prisms 9 and the like to the pair of left and right eyepiece parts 14 for the left and right eyes of the doctor D1. Due to the convergence angle “θ (theta)”, the primary images F1 from the eyepiece parts 14 involve binocular parallax, and therefore, are stereoscopically observable.

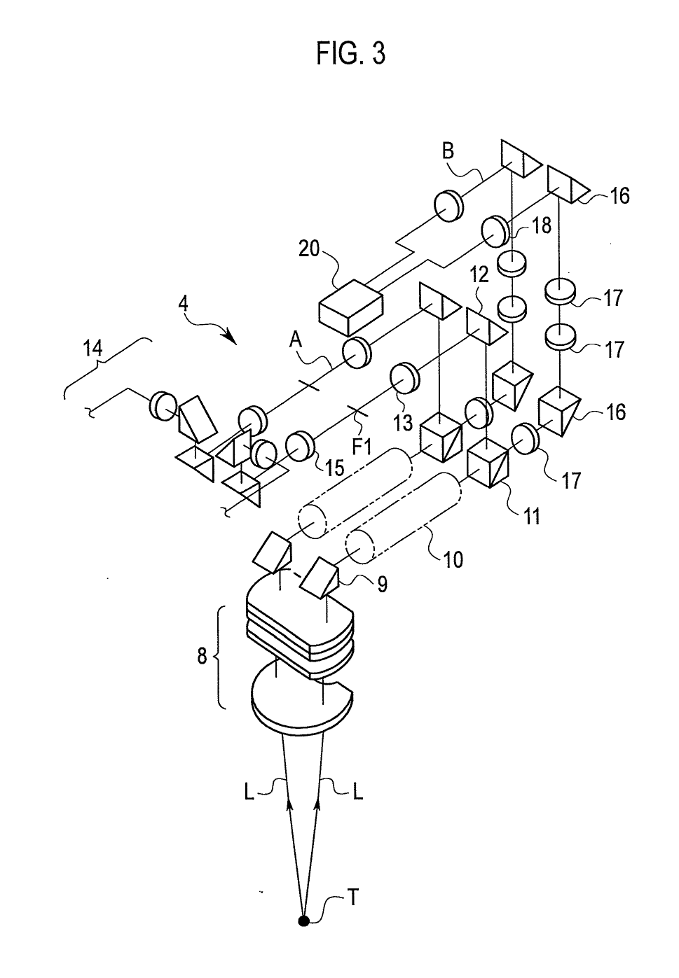

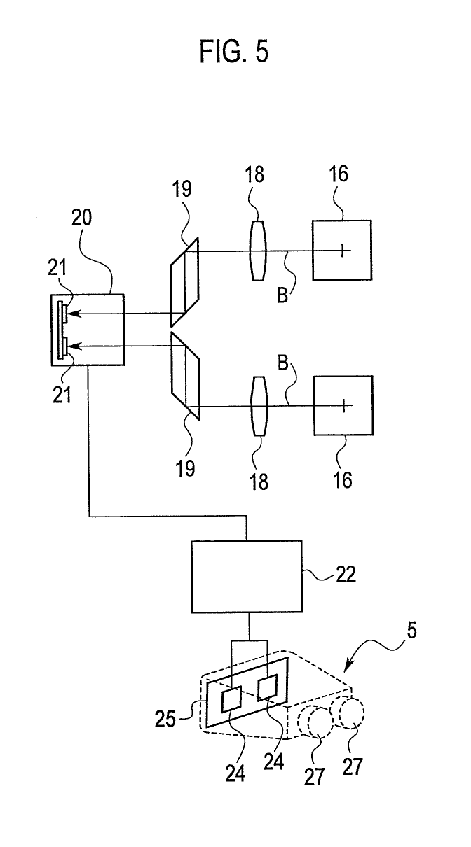

The main optical paths A are split by the beam splitters 11 into sub-optical paths B, respectively. As illustrated in FIGS. 3 and 5, the sub-optical paths B pass through prisms 16, lenses 17, relay lenses 18, and parallelogram prisms 19 to a camera 20 installed on the surgical microscope 4.

The camera 20 incorporates a pair of left and right CCD image sensors (hereinafter referred to as “CCDs”) 21 that are two-dimensional photographing elements. The CCDs 21 pick up a pair of electronic images having binocular parallax. In front of the CCDs 21, focus adjustment lenses 41 and 42 are arranged. Among them, the lenses 42 are moved by a servo mechanism 43. The lenses 41 and 42 and servo mechanism 43 form the “focusing mechanism” stipulated in the claims.

In front of the lenses 41 and 42, a rotary plate 44 is arranged. The rotary plate 44 has four holes in which a pair of transmission observation glasses (having an infrared cutting function) 45 and a pair of fluorescence observation filters 46 are arranged. The filters 46 are band-pass filters to selectively transmit light of a predetermined wavelength band depending on a fluorescent material. The rotary plate 44 is turned by a motor 47 to select the transmission glasses 45 or the filters 46. The electronic images picked up by the CCDs 21 of the camera 20 are outputted through a controller 22 to the electronic image display unit 5.

The electronic image display unit 5 has a casing 23 that incorporates a pair of left and right display panels 24. The display panels 24 are organic electroluminescence panels according to the present embodiment and are assembled to a substrate 25 that receives electronic image signals from the controller 22. The casing 23 also incorporates a partition 26 that separates an inner space of the casing 23 into two. Opposite to the display panels 24, the casing 23 has a pair of left and right eyepiece parts 27 that each include an eyepiece optical system 28.

In addition to the eyepiece parts 27, the casing 23 incorporates objective optical systems 29, imaging optical systems 30, and relay optical systems R arranged between the optical systems 29 and 30. Each objective optical system 29 receives light from the corresponding display panel 24 and each imaging optical system 30 forms a primary image F2 from light transmitted through the corresponding objective optical system 29. Each primary image F2 is enlarged through the eyepiece optical system 28 and is observed by the eye of the assistant D2. When seeing the primary image F2, the eye of the assistant D2 is placed on an eye point where light from the eyepiece optical system 28 crosses. The pair of left and right display panels 24 display the electronic images having binocular parallax, and therefore, the assistant D2 is able to stereoscopically observe the images through the eyepiece parts 27.

A side face of the casing 23 of the electronic image display unit 5 is provided with a switch 48 to operate the servo mechanism 43 of the camera 20. Operating the switch 48 results in moving the lenses 42 and focusing the lenses 42 with respect to the CCDs 21.

According to the present embodiment, the electronic image display unit 5 of the assistant D2 is separately supported from the surgical microscope 4 used by the doctor D1. Accordingly, even if the doctor D1 moves the surgical microscope 4, the electronic image display unit 5 causes no movement. Namely, the doctor D1 and assistant D2 are allowed to freely move the surgical microscope 4 and electronic image display unit 5, respectively, without interfering with each other. This improves operability of the devices 4 and 5 for the two persons.

The electronic image display unit 5 incorporates the objective optical systems 29 and imaging optical systems 30 in the casing 23. The primary images F2 formed through these optical systems 29 and 30 are observed through the eyepiece optical systems 28. Namely, the display unit 5 allows the assistant D2 to naturally observe the primary images F2 as if observing the images through the surgical microscope 4. This improves an observation performance of the display unit 5 and causes no fatigue on the assistant D2 even after a long time of observation.

Accommodating the objective optical systems 29 and imaging optical systems 30 in the casing 23 of the electronic image display unit 5 improves an optical performance of the display unit 5. Depending on the resolution and response speed of the display panels 24, the display unit 5 is able to provide finer electronic images. The display panels 24 made of organic electroluminescence panels are superior to liquid crystal panels in response speed and contrast and such superior characteristics can fully be utilized when images on the display panels 24 are observed through the objective optical systems 29, imaging optical systems 30, and eyepiece parts 27.

According to the present embodiment, the camera 20 is provided with the focusing mechanism that operates separately. When the doctor D1 adjusts the surgical microscope 4 to a focal point of his or her eye by vertically moving the surgical microscope 4 instead of controlling the internal optical system of the surgical microscope 4, the camera 20 causes an out-of-focus state. In this case, the assistant D2 operates the focusing mechanism to focus the lenses 42 with respect to the CCDs 21 in the camera 20 so that the electronic image display unit 5 may provide clear electronic images.

This focusing operation of the camera 20 is achievable with the switch 48 arranged on a side face of the electronic image display unit 5, and therefore, the assistant D2 is able to easily and correctly conduct the focusing operation while observing the images provided by the display unit 5.

According to the first embodiment, the rotary plate 44 is arranged for the CCDs 21. The rotary plate 44 is turnable to use the filters 46 that transmit light of a predetermined wavelength band to form images on the CCDs 21. In this case, the images from the CCDs 21 allow a fluorescence observation.

### Second Embodiment

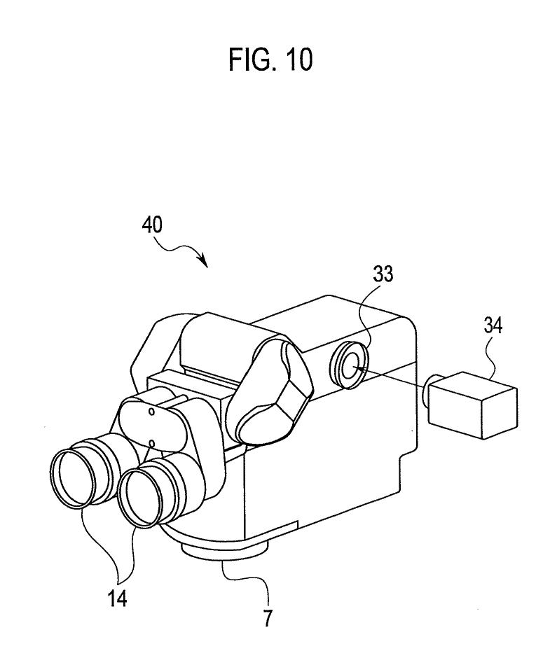

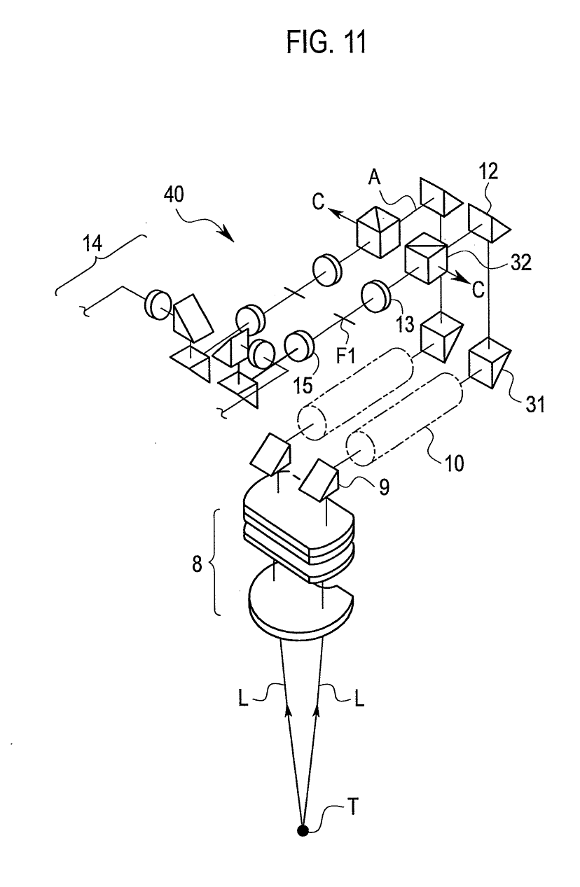

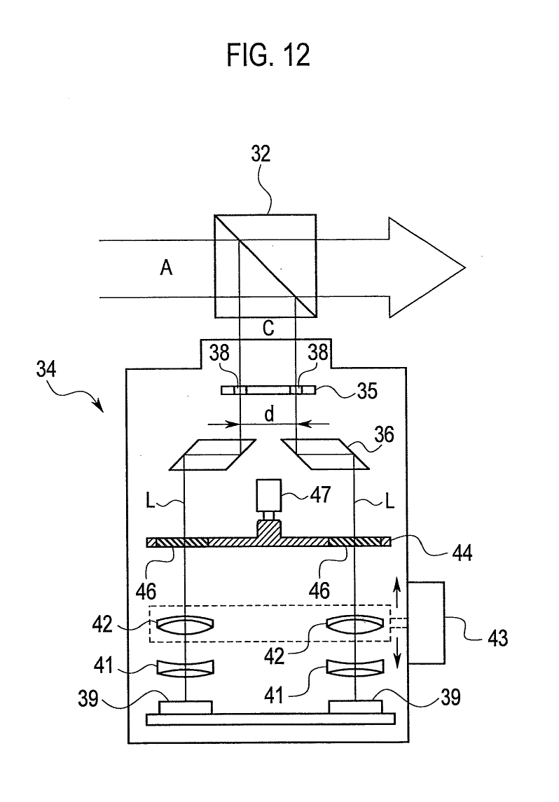

A surgical microscope system according to the second embodiment of the present invention will be explained with reference to FIGS. 10 to 12. The second embodiment is similar to the first embodiment, and therefore, like elements are represented with like reference marks in FIGS. 10 to 12 to omit overlapping explanations.

The surgical microscope system according to the second embodiment employs a surgical microscope 40. In the surgical microscope 40, main optical paths A are totally upwardly reflected by prisms 31 and are bent toward eyepiece parts 14. Unlike the first embodiment, the second embodiment creates no sub-optical paths that run through the inside of the surgical microscope 40.

Instead, the second embodiment arranges beam splitters 32 in the main optical paths A in front of imaging optical systems 13. Each beam splitter 32 branches the corresponding main optical path A at a right angle into a sub-optical path C. The sub-optical path C goes outside from a light outlet 33 arranged on the right (left) side of the surgical microscope 40. According to the second embodiment, only the light outlet 33 on the right side is used and the light outlet 33 on the left side is closed. The light outlet 33 on the right side is connected to a camera 34.

The camera 34 incorporates a light dividing unit that includes a slit plate 35, a pair of left and right parallelogram prisms 36, and the like.

The slit plate 35 has a pair of left and right holes 38 to divide the sub-optical path C branched by the beam splitter 32 of the surgical microscope 40 into two parallel beams L that are guided to CCDs 39.

Similar to the first embodiment, the second embodiment arranges, in front of the CCDs 39, lenses 41 and 42, a servo mechanism 43, and a rotary plate 44. The rotary plate 44 has filters 46. The servo mechanism 43 drives and moves the lenses 42. The two parallel beams L are transmitted through the rotary plate 44 and lenses 42 and 41 and are guided to the CCDs 39, respectively. The CCDs 39 form electronic images from the beams L and the electronic images are outputted through a controller to an electronic image display unit 5.

In this way, the second embodiment branches one of the main optical paths A of the surgical microscope 40 into the sub-optical path C and divides the sub-optical path C into the two parallel beams L. Accordingly, the parallel beams L involve a slight parallax as depicted by d. Due to this parallax, the electronic image display unit 5 provides pseudo three-dimensional images instead of simple two-dimensional images.

Although the first and second embodiments support the electronic image display unit 5 on the right side of the surgical microscope 4 (40), the display unit 5 may be placed at any position with respect to the surgical microscope 4 (40). For example, the display unit 5 may be arranged on the left side of the surgical microscope 4 (40), or at a position opposite to the doctor D1.

The electronic image display unit 5 is usable not only for the assistant D2 but also for nurses or interns for their study by installing it in a room other than the operating room.

The display panels 24 of the electronic image display unit 5 are not limited to the organic electroluminescence display panels. They may be transmissive liquid crystal display panels, reflective liquid crystal display panels, or any other display panels.

This application claims benefit of priority under 35USC §119 to Japanese Patent Application No. 2013-015347, filed on Jan. 30, 2013, the entire contents of which are incorporated by reference herein.

What is claimed is:

1. A surgical microscope system comprising:
a surgical microscope movably supported in a vertical direction, having an objective optical system, variable-power optical systems, and a pair of left and right eyepiece parts to form two main optical paths, and at least one of the main optical paths being branched into a sub-optical path;
a camera installed on the surgical microscope and having a pair of left and right imaging elements for receiving light from the sub-optical path and providing electronic images;
an electronic image display unit having a pair of left and right display panels for displaying the electronic images provided by the camera and a pair of eyepiece parts through which an observer is able to observe the displayed images with his or her eyes, respectively; and
a focusing mechanism arranged for the imaging elements in the camera.

2. The surgical microscope system of claim 1, further comprising a switch for controlling the focusing mechanism and arranged on the electronic image display unit.

3. The surgical microscope system of claim 1, further comprising a filter for transmitting light of only a specific wavelength band to the imaging elements and moved to and away from a position in front of the imaging elements in the camera.
